(19) United States
(12) Patent Application Publication
(10) Pub. No.: US 2014/0108240 A1
(43) Pub. Date: Apr. 17, 2014

(54) PAYMENT PREFERENCE USER INTERFACE

(71) Applicants: Jeff Loman, San Francisco, CA (US); Adam Prishtina, San Francisco, CA (US); Egan Schulz, San Jose, CA (US); Tim Smith, San Jose, CA (US); Laura Ward, San Jose, CA (US)

(72) Inventors: Jeff Loman, San Francisco, CA (US); Adam Prishtina, San Francisco, CA (US); Egan Schulz, San Jose, CA (US); Tim Smith, San Jose, CA (US); Laura Ward, San Jose, CA (US)

(21) Appl. No.: 13/906,996

(22) Filed: May 31, 2013

Related U.S. Application Data
(60) Provisional application No. 61/714,850, filed on Oct. 17, 2012.

(51) Int. Cl. G06Q 20/10

(52) U.S. Cl. CPC G06Q 20/10
USPC 705/40

(57) ABSTRACT

A display shows who a user owes money to on one side of the display and who the user is owed money by on the other side of the display. The parties are shown with a visual representation (e.g., a photo or text), a name, and an amount. The more someone owes or is owed, the farther they are shown extending from the center-line (or 0 owed/is owed line). The user can select a person/entity that the user owes money to by tapping and dragging the visual image and then moving that selection to the same row as a person/entity that owes money to the user. This allows the user to pass some of the money owed to the user to pay the person/entity that the user owes money to. Once confirmed, the tree is updated. The payment provider may facilitate the money exchange between the two selected parties and the user.

### CROSS REFERENCE TO RELATED APPLICATION

The present application claims priority to U.S. Provisional Patent Application Ser. No. 61/714,850, filed Oct. 17, 2012, which is incorporated by reference in its entirety.

### BACKGROUND

1. Technical Field

The present application generally relates to online payments and more particularly to managing online payments.

2. Related Art

People typically make a purchase and complete the payment at the time of purchase. However, there are many situations where a person may owe another person or entity money and be owed money from another person or entity. Such situations may arise when someone borrows or lends money, such as with a group purchase, meal with friends, etc.

It may be difficult to keep track and manage everyone who owes money and is owed money. It may be even more difficult or cumbersome to collect money from others and pay others.

### BRIEF DESCRIPTION OF THE DRAWINGS

FIG. 1 is a flowchart showing a process a service provider makes in presenting a payment tree display and processing payments from the tree according to one embodiment;

FIGS. 2A and 2B are exemplary screen shots and illustrative text showing a payment tree according to different embodiments;

FIGS. 3A-3D are exemplary screen shots and illustrative text showing a sequence of displays the user may see in conducting a payment transaction according to one embodiment;

FIG. 4 is a block diagram of a networked system configured for presenting a payment tree display and processing payments from the tree in accordance with an embodiment; and

FIG. 5 is a block diagram of a computer system suitable for implementing one or more embodiments of the present disclosure.

### DETAILED DESCRIPTION

In one embodiment, a display shows who a user owes money to (people or entities/accounts) on one side of the display and who the user is owed money by (people or entities/accounts) on the other side of the display. The parties are shown with a visual representation (e.g., a photo or text), a name, and an amount. The more someone owes or is owed, the farther they are shown extending from the center-line (or 0 owed/is owed line).

In another embodiment, the user can select a person/entity that the user owes money to by tapping and dragging the visual image and then moving that selection to the same row as a person/entity that owes money to the user. This allows the user to pass some of the money owed to the user to pay the person/entity that the user owes money to. Once confirmed, the tree is updated. The payment provider may facilitate the money exchange between the two selected parties and the user.

Thus, the user is provided an easy to user visual interface for managing money owed by and to the user and to facilitate payments between the two sides.

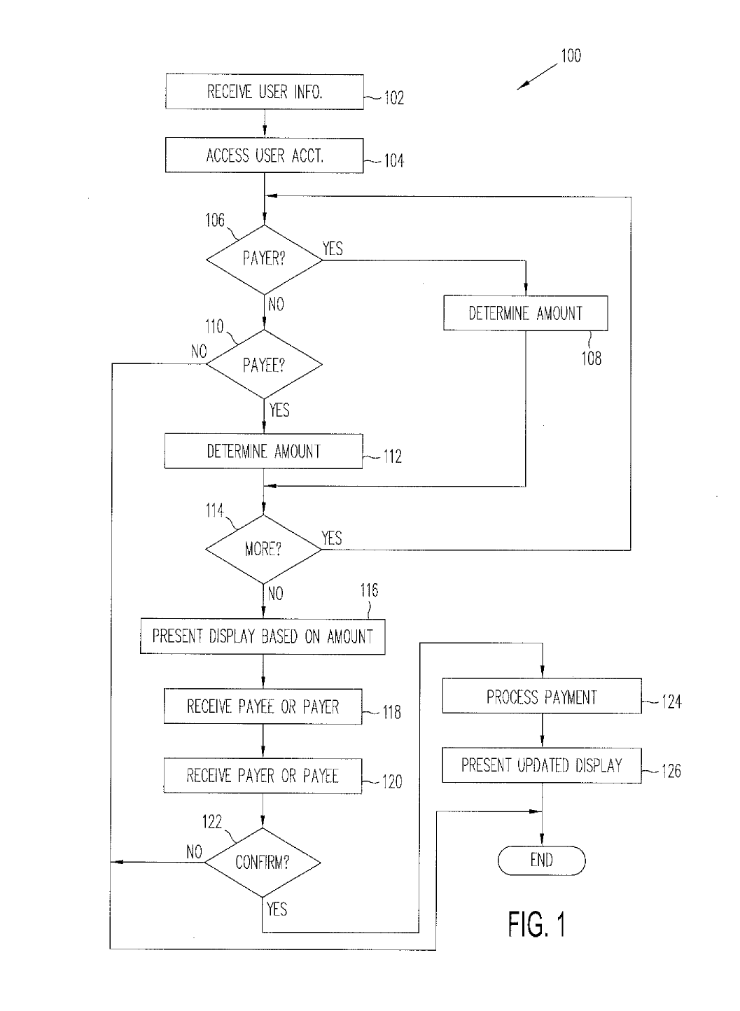

FIG. 1 is a flowchart 100 showing a process a service provider makes in presenting a payment tree display and processing payments from the tree according to one embodiment. At step 102, the payment provider receives user information, such as information sent from a user device to a payment provider device. The user device may be a smart phone, PC, computing tablet, or other computing/communication device, and the payment provider device may be a server, processor, or other computing device that is able to receive electronic information. The user information may include a user name, an email address, a phone number, along with a PIN or password.

Using the user information, the payment provider then accesses, at step 104, an account associated with the user. The payment provider may search one or more databases or memories storing user accounts using one or more user/account identifiers and the PIN/password.

If a valid user account is located, it is accessed to determine, at step 106, whether a user payer exists. A user payer or payer, as used herein, is a person, merchant, organization, or other entity that owes the user money. For example, a payer may be a person or friend who the user loaned money to, such as a cash loan or to cover that person's portion in a group purchase, meal, or other shared expense. A payer may also be an entity that has borrowed money from the user or owes the person for a service performed, for example.

If a payer exists, the amount owed by the payer to the user is determined, at step 108. The amount can be determined from information contained in the user account, such as through a transaction processed by the payment provider, reported by the user, reported by the payer, reported by a third party, or other means. The amount may range from something nominal, such as $1.00 or less, to large amounts, such as $1000 or more. If, as determined at step 106, a person or entity is not a payer, a determination is made, at step 110, whether the person or entity is a user payee. A user payee or payee, as used herein, is a person, merchant, organization, or other entity that is owed money by the user. For example, a payee may be a person or friend who has loaned money to the user, such as a cash loan or to cover the user's portion of a group purchase, meal, or other shared expense. A payee may also be an entity that has loaned money to the user or a person/entity who has performed a service for or provided an item to the user that has not yet been fully paid for.

If a payee is found, at step 110, the amount owed to the payee is determined, at step 112. As with step 108, the amount may be determined from information stored with the user account and provided by the payment provider or other entities/persons.

Thus, with steps 106-112, the payment provider determines one payee or payer and the amount owed to the payee or owed from the payer.

At step 114, a determination is made whether there are more payees or payers for the user. If so, steps 106-112 are repeated. They are repeated until all payees and payers have been determined, along with associated amounts.

Once that happens, the user is presented, on a user device, a display based on the determined amounts at step 116. The payment provider may electronically communicate data to the user device to enable the user device to display the desired information and graphics to the user on the device. Sample displays will be shown in the figures.

In one embodiment, the display has a vertical line that separates payees on one side of the line and payers on the other side of the line. The line can be viewed as a “zero owed/zero owe” line. Payees on one side of the line may have an identifier, such as a photo and/or name, along with a visual indication of amount that the payee is owed by the user. The visual indication may include a text number amount, such as “$53.25”, along with a horizontal bar extending from the vertical line. The length of the bar may correspond to the amount. For example, a payee that is owed $100 from the user may have a bar length longer or approximately twice as long as a payee that is owed $50 from the user. The bars may also have different colors and/or brightness based on amount. For example, payees that are owed more may have brighter bars and/or brighter colors, such as red. As such, the user is presented with an easy to understand display of who the user owes money to and who owes money to the user.

In one embodiment, the display is interactive in that the user can select a displayed payee and a displayed payer for a payment directly from the selected payer to the selected payee, resulting in relieving the user of an obligation to pay the selected payee and the selected payer of an obligation to pay the user. Visual examples will be provided below. For example, a user may select a payer that owes the user $100 and a payee that the user owes $100 so that the payer can pay the payee directly to cancel both obligations completely. In another example, with the same payer, the user may select a payee that the user owes S200. In that case, the payer pays the payee $100, which eliminates the obligation of the payer to the user and reduces the user obligation to the payee from $200 to $100. In yet another example, with the same payer, the payee selects a payee that the user owes $60. Here, the payer pays $60 to the payee, eliminating the user debt to the payee and reducing the obligation of the payer down to $40 owed to the user.

Note that the user can select more than one payers or payees to combine amounts as desired. For example, the user may select a payer that owes the user $100 and select a payee that the user owes $40 and another payee that the user owes $60. By combining payees, the user can relieve the obligation associated with both the payer and the two payees. In other embodiments, the user may modify the amount owed or is owed to such that not the full amount is used in the transaction. For example, if a selected payer owes the user $100, the user may choose to use only $40 of that amount for payment to one or more selected payees, even though the $40 does not completely pay off the one or more selected payees.

Returning to FIG. 1, the payment provider receives, at step 118, one or more payees or payers from one side of the vertical line on the display. Selection may be made in any suitable way, including tapping on a desired payee or payer, selecting a field/box associated with the desired payee or payer, and clicking on the desired payee or payer.

Similarly, at step 120, the payment provider receives one or more payers or payees from the user, i.e., persons and/or entities from the other side of the vertical line of the display. Selection may be the same as in step 118. In another embodiment, the selection is done by the user moving (such as by dragging and dropping) a person/entity on one side to a person/entity on the other side of the vertical line.

Once the selections are received, the user is presented with a display that shows the selected payees/payers, along with amounts, such how much will be transferred from each selected payer to each selected payee. The display may also allow the user to confirm the selections, such as with a button, link, or box that the user selects.

If the user confirms the selections, as determined at step 122, the payment provider processes the transaction/payment at step 124. Processing may include debiting an account of the selected user payer(s) in the amount designated and crediting an account of the selected user payee(s) in the amount designated. The accounts may be maintained by the payment provider, and if none exist, the payee or payer may be requested to open an account to process the payment. In one embodiment, the selected payee(s) and/or the selected payer(s) may be notified, such as on their devices, of the proposed transaction and to confirm before the transaction can be processed. The notification may include the names of the parties involved, e.g., the user, the payee(s), and/or the payer(s), the amount, and any note from the user, such as “This is to satisfy a debt I owe user A by having user B, who owes me money, to pay user A directly.”

Once the transaction is processed, partially or completely, the user is presented with an updated display at step 126. A partial completion may happen if one or more payer or payee does not accept the proposed payment, but one or more other payees or payers do accept. If an obligation by the user to pay a payee and/or an obligation of a payer to pay the user is completely satisfied, that party will no longer be shown on the display. If an obligation is partially satisfied, the horizontal bar will be shortened and the amount shown will be reduced.

Thus, using embodiments described herein, a user can easily see and understand who the user owes money to and who owes the user money and in what amounts. The user can also easily satisfy, partially or completely, various obligations by having one or more user payer pay one or more user payee directly.

Note that one or more steps described herein may be omitted, combined, or performed in a different sequence as desired.

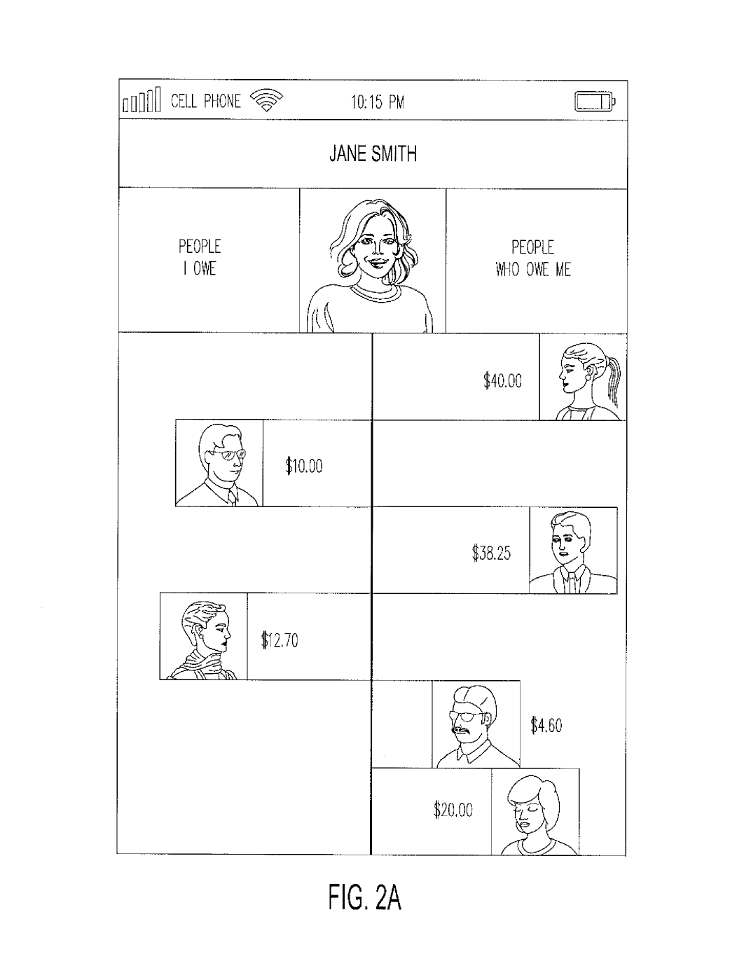

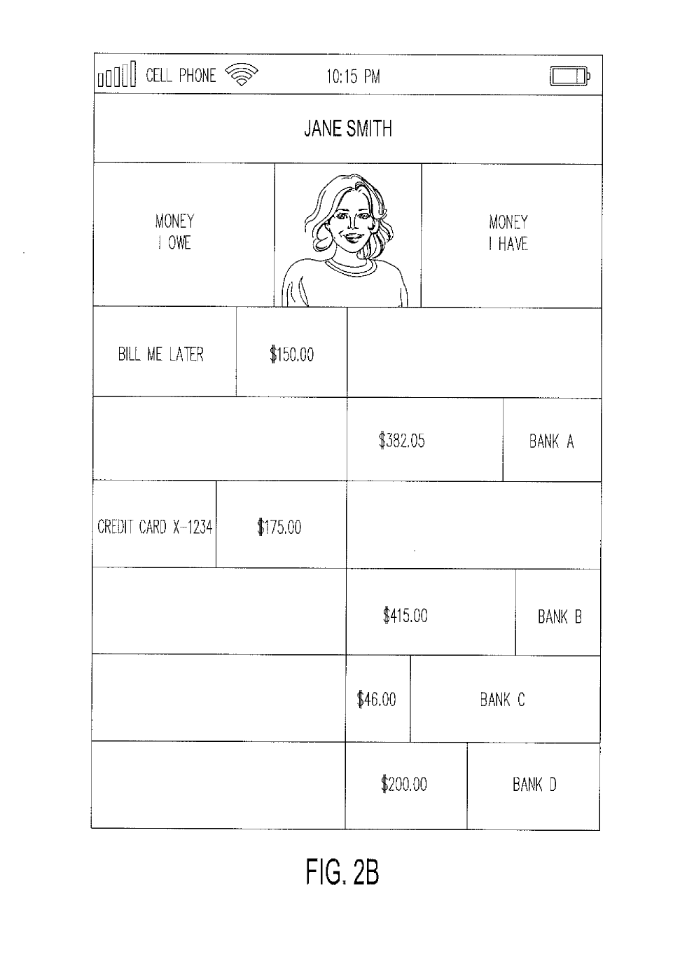

FIGS. 2A and 2B are exemplary screen shots and illustrative text showing a payment tree according to different embodiments. In FIG. 2A, a display from the user device shows the user name and photo on the top, with people the user owes money to on the left of a vertical line and people that owe money to the user on the right of the vertical line. Each person is shown with a photo and an amount owed or owed to. Each person extends a specific length from the vertical line, based on the amount. Thus, as seen, the person that owes the user $4.60 is associated with a shorter horizontal bar than the person who owes the user $40.00.

In FIG. 2B, the display shows entities that are payers and payees, instead of individuals shown in FIG. 2A. As will be appreciated, a single display may show both persons and individuals if desired. The entities in FIG. 2B include names of the entities, amount owed or owed to, and an amount-based horizontal bar. Entities may also be shown with an entity logo.

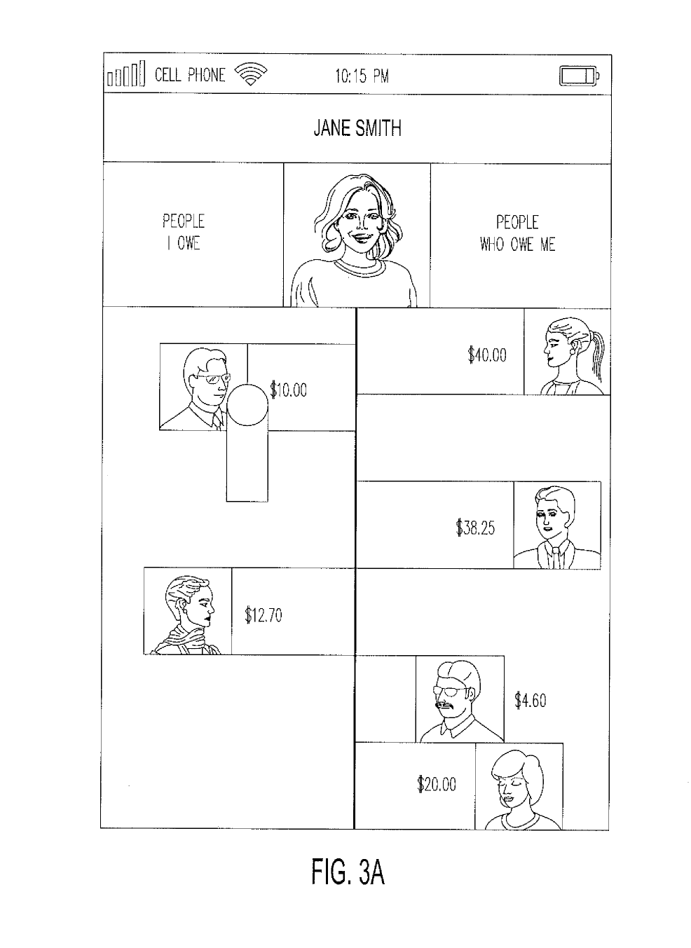

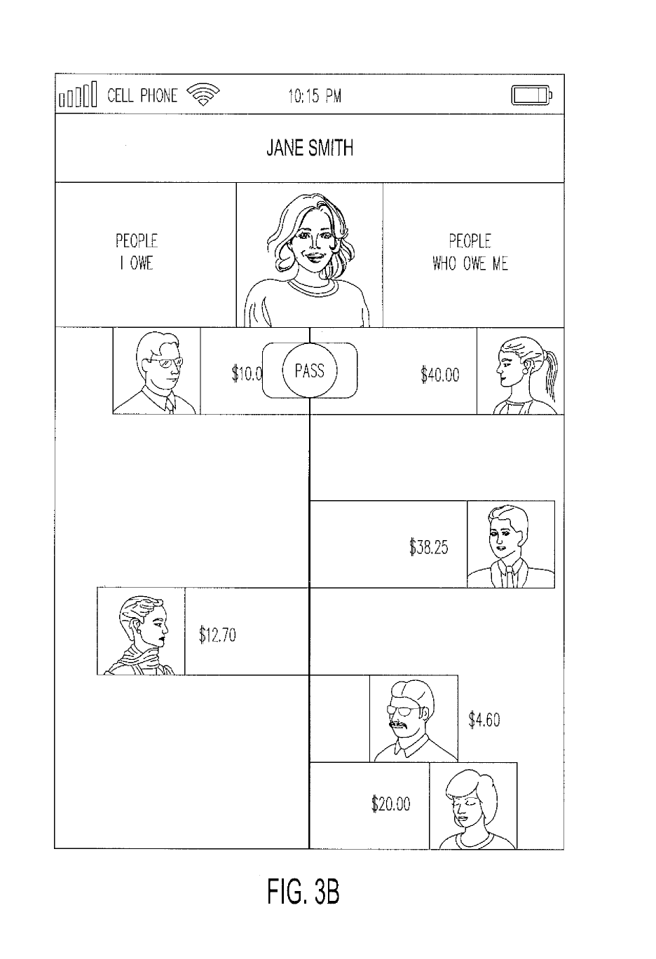

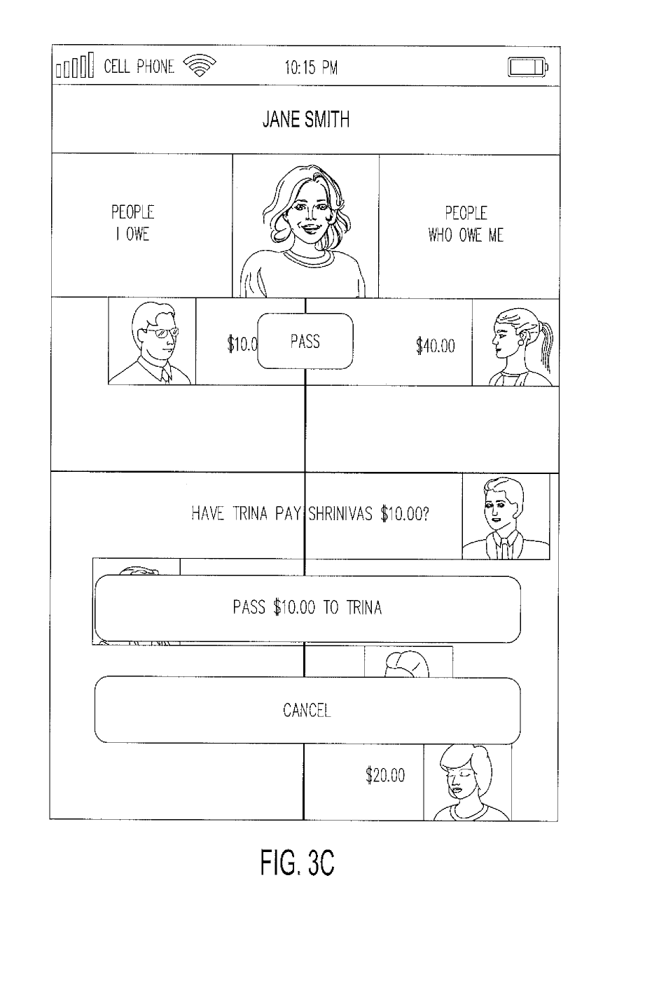

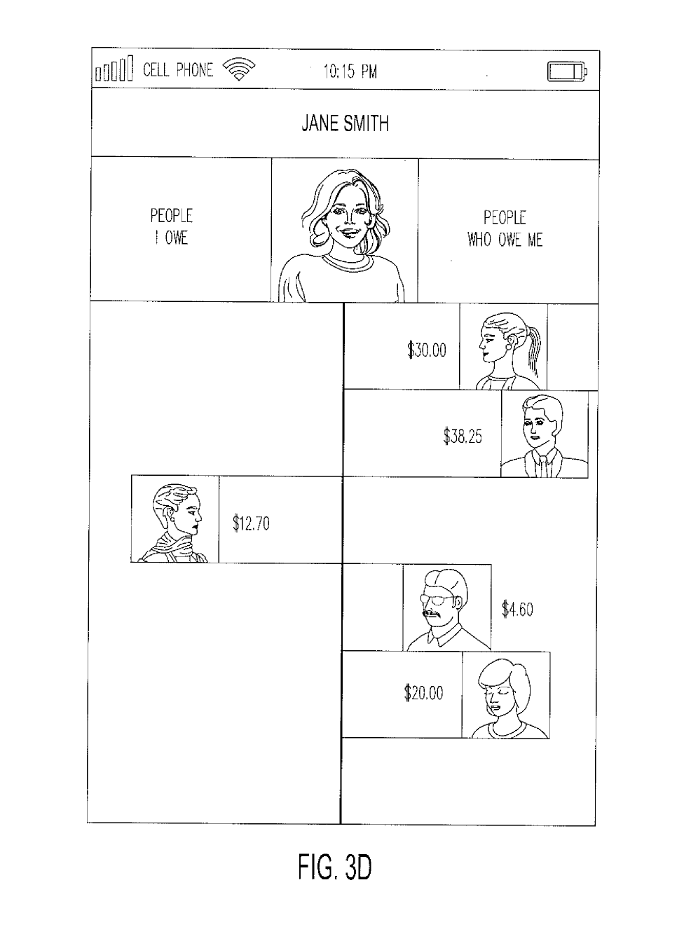

FIGS. 3A-3D are exemplary screen shots and illustrative text showing a sequence of displays the user may see in conducting a payment transaction according to one embodiment. In FIG. 3A, the user sees a display showing people who are owed money by the user on the left and people who owe money to the user on the right, along with amounts and amount-based horizontal bars. In FIG. 3A, the user selects the payee on the left that the user owes $10.00 to. The user selects the payee by tapping or tapping and holding the bar or image associated with the desired payee. The user can then select a desired payer on the right side of the display by dragging or moving the selected payee to the desired payer. Here, the user drags the person that is owed $10 by the user to the person that owes the user $40. The user then removes the finger from the screen to convey the selection.

In FIG. 3B, the selected payee and selected payer are horizontally aligned, along with a “Pass” button that indicates the user payer who owes the user $40 will pass or pay the user payee who the user owes $10.

FIG. 3C shows a display after the user has selected, such as by tapping, the “Pass” button. In the display, the user is provided details of the transaction or transfer with an option to confirm or cancel the proposed transaction.

FIG. 3D is a revised display after the user confirms the proposed transaction. As seen, the user payee who had owed the user $10 is no longer shown, as that obligation to the user has been satisfied by the user payer who had owed the user $40. The user who had owed the user $40 is now shown as owing only $30, with a corresponding shorter horizontal bar. As a result, the user payment tree is simplified with a direct payment between a user payee and a user payer.

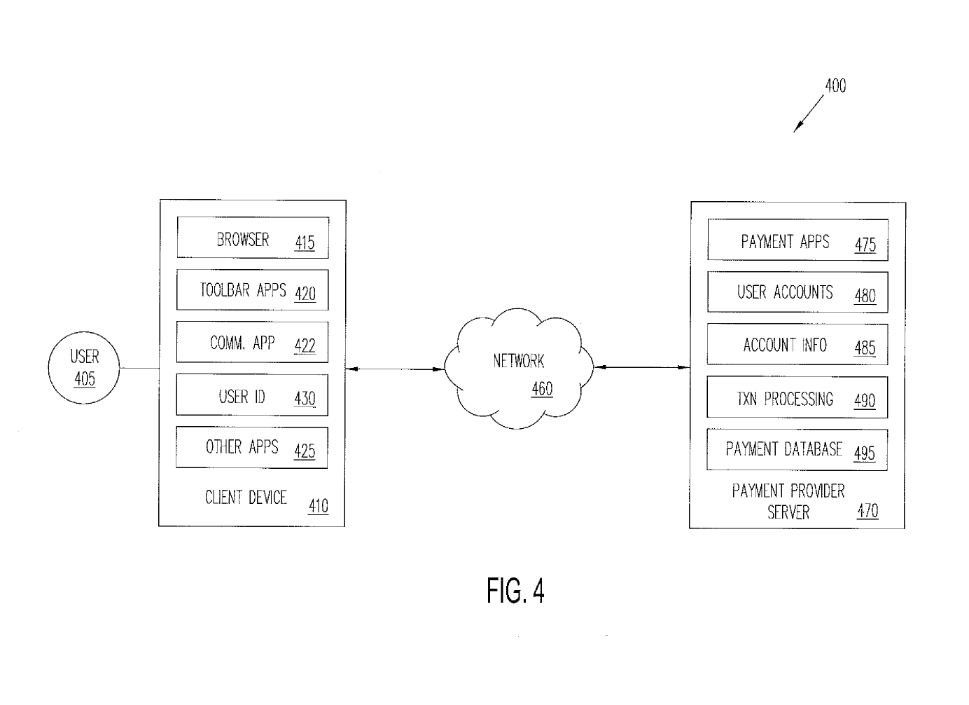

FIG. 4 is a block diagram of a networked system 400 configured for presenting a payment tree display and processing payments from the tree, such as described above, in accordance with an embodiment of the invention. System 400 includes a user device 410 and a payment provider server 470 in communication over a network 460. Payment provider server 470 may be maintained by a payment provider, such as PayPal, Inc. of San Jose, Calif. Although a payment provider device is shown, the server may be managed or controlled any suitable service provider that requires authentication as a human before communicating information. A user 405 utilizes user device 410 to view account information and perform transaction using payment provider server 470. Note that transaction, as used herein, refers to any suitable action performed using the user device, including payments, transfer of information, display of information, etc. Although only one server is shown, a plurality of servers may be utilized. Exemplary servers may include, for example, stand-alone and enterprise-class servers operating a server OS such as a MICROSOFT® OS, a UNIX® OS, a LINUX® OS, or other suitable server-based OS. One or more servers may be operated and/or maintained by the same or different entities.

User device 410 and payment provider server 470 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

Network 460 may be implemented as a single network or a combination of multiple networks. For example, in various embodiments, network 460 may include the Internet or one or more intranets, landline networks, wireless networks, and/or other appropriate types of networks.

User device 410 may be implemented using any appropriate hardware and software configured for wired and/or wireless communication over network 460. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 410 may include one or more browser applications 415 which may be used, for example, to provide a convenient interface to permit user 405 to browse information available over network 460. For example, in one embodiment, browser application 415 may be implemented as a web browser configured to view information available over the Internet, such as user payees and payers and information other from the payment provider. User device 410 may also include one or more toolbar applications 420 which may be used, for example, to provide client-side processing for performing desired tasks in response to operations selected by user 405. In one embodiment, toolbar application 420 may display a user interface in connection with browser application 415 as further described herein.

User device 410 may further include other applications 425 as may be desired in particular embodiments to provide desired features to user device 410. For example, other applications 425 may include security applications for implementing client-side security features, programmatic client applications for interfacing with appropriate application programming interfaces (APIs) over network 460, or other types of applications. Applications 425 may also include email, texting, voice and IM applications that allow user 405 to send and receive emails, calls, and texts through network 460, as well as applications that enable the user to communicate and transfer information through and with the payment provider as discussed above. User device 410 includes one or more user identifiers 430 which may be implemented, for example, as operating system registry entries, cookies associated with browser application 415, identifiers associated with hardware of user device 410, or other appropriate identifiers, such as used for payment/user/device authentication. In one embodiment, user identifier 430 may be used by a payment service provider to associate user 405 with a particular account maintained by the payment provider. A communications application 422, with associated interfaces, enables user device 410 to communicate within system 400.

Payment provider server 470 may be maintained, for example, by an online payment service provider which may provide information to and receive information from user 405, such as for making payments. In this regard, payment provider server 470 includes one or more payment applications 475 which may be configured to interact with user device 410 over network 460 to facilitate sending payments from user 405 of user device 410.

Payment provider server 470 also maintains a plurality of user accounts 480, each of which may include account information 485 associated with consumers, merchants, and funding sources, such as credit card companies. For example, account information 485 may include private financial information of users of devices such as account numbers, passwords, device identifiers, user names, phone numbers, credit card information, bank information, identification cards, photos, who owes what to a user, what and to whom a user owes, or other information which may be used to facilitate transactions by user 405.

A transaction processing application 490, which may be part of payment application 475 or separate, may be configured to receive information from a user device for processing and storage in a payment database 495. Transaction processing application 490 may include one or more applications to process information from user 405 for processing a payment or transfer using various selected funding instruments or cards. As such, transaction processing application 490 may store details of payment transfer from individual users, including funding source(s) used, credit options available, etc. to other individuals or entities. Payment application 475 may be further configured to determine the existence of and to manage accounts for user 405, as well as create new accounts if necessary, such as the set up and management payments by the user.

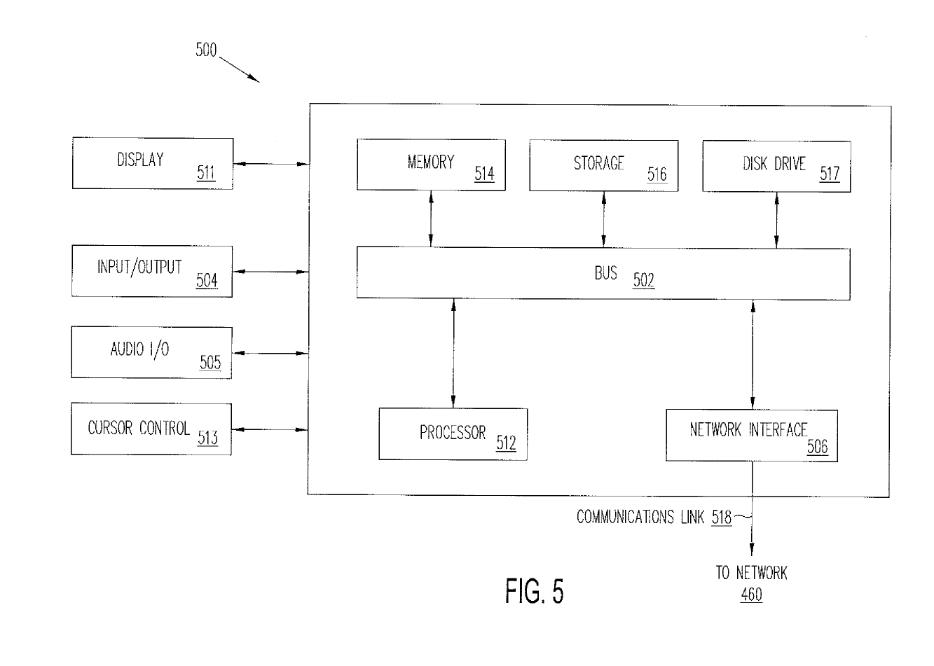

FIG. 5 is a block diagram of a computer system 500 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The payment provider may utilize a network computing device (e.g., a network server) capable of communicating with the network. It should be appreciated that each of the devices utilized by users and payment providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a payment provider server via network 460. In one embodiment, the transmission is wireless, although other transmission mediums and methods may also be suitable. A processor 512, which can be a micro-controller, digital signal processor (DSP), or other processing component, processes these various signals, such as for display on computer system 500 or transmission to other devices via a communication link 518. Processor 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. For example, the display is shown and described as a vertical line. However, other separators, such as a horizontal line or diagonal line may also be suitable to separate payees from payers. The separator does not need to be a straight line. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account information, wherein the information comprises at least an identity of one user payee and an amount owed by a user to the payee and at least an identity of one user payer and an amount owed by the payer to the user; and
one or more hardware processors in communication with the non-transitory memory and configured for:
determining an identity of each of a plurality of user payers;
determining an amount owed by each of the user payers to a user;
determining an identity of each of a plurality of user payees;
determining an amount the user owes to each of the user payees; and
communicating, to a user device, data that enables the user device to display a payment tree, wherein the payment tree comprises a first area showing each of the user payers, an amount owed to the user by each of the user payers, and a first visual indicator having a parameter dependent upon the amount owed and a second area showing each of the user payees, an amount the user owes to each of the user payees, and second visual indicator having a parameter dependent upon the amount the user owes to each of the user payees.

2. The system of claim 1, wherein the first and second visual indicators is a bar or line, and the parameter is a length of the bar or line.

3. The system of claim 2, wherein the bars or lines extend from a zero owed/zero owes visual line.

4. The system of claim 1, wherein the payees and the payers comprises individuals and/or entities.

5. The system of claim 1, wherein the payment tree enables the user to select at least one user payee from the payment tree and at least one user payer from the payment tree to allow a payment provider to process a payment from the selected user payer(s) to the selected user payee(s).

6. The system of claim 5, wherein the payment tree is updated to reflect the payment.

7. The system of claim 5, wherein the user selects the payee(s) by moving the selected payer(s) to a desired payee(s).

8. The system of claim 5, wherein the user selects the desired payer(s) by moving the selected payee(s) to a desired payer(s).

9. A method comprising:
determining, electronically by a hardware processor of a service provider, an identity of each of a plurality of user payers;
determining an amount owed by each of the user payers to a user;
determining an identity of each of a plurality of user payees;
determining an amount the user owes to each of the user payees; and
communicating, to a user device, electronic data that enables the user device to display a payment tree, wherein the payment tree comprises a first area showing each of the user payers, an amount owed to the user by each of the user payers, and a first visual indicator having a parameter dependent upon the amount owed and a second area showing each of the user payees, an amount the user owes to each of the user payees, and second visual indicator having a parameter dependent upon the amount the user owes to each of the user payees.

10. The method of claim 9, wherein the first and second visual indicators is a bar or line, and the parameter is a length of the bar or line.

11. The method of claim 10, wherein the bars or lines extend from a zero owed/zero owes visual line.

12. The method of claim 9, wherein the payees and the payers comprises individuals and/or entities.

13. The method of claim 9, wherein the payment tree enables the user to select at least one user payee from the payment tree and at least one user payer from the payment tree to allow a payment provider to process a payment from the selected user payer(s) to the selected user payee(s).

14. The method of claim 13, wherein the payment tree is updated to reflect the payment.

15. The method of claim 13, wherein the user selects the payee(s) by moving the selected payer(s) to a desired payee(s).

16. The method of claim 13, wherein the user selects the desired payer(s) by moving the selected payee(s) to a desired payer(s).

17. A non-transitory computer readable medium comprising a plurality of machine-readable instructions which when executed by one or more processors of a server are adapted to cause the server to perform a method comprising:
determining an identity of each of a plurality of user payers;
determining an amount owed by each of the user payers to a user;
determining an identity of each of a plurality of user payees;
determining an amount the user owes to each of the user payees; and
communicating, to a user device, data that enables the user device to display a payment tree, wherein the payment tree comprises a first area showing each of the user payers, an amount owed to the user by each of the user payers, and a first visual indicator having a parameter dependent upon the amount owed and a second area showing each of the user payees, an amount the user owes to each of the user payees, and second visual indicator having a parameter dependent upon the amount the user owes to each of the user payees.

18. The transitory computer readable medium of claim 17, wherein the first and second visual indicators is a bar or line, and the parameter is a length of the bar or line.

19. The transitory computer readable medium of claim 18, wherein the bars or lines extend from a zero owed/zero owes visual line.

20. The transitory computer readable medium of claim 17, wherein the payees and the payers comprises individuals and/or entities.

21. The transitory computer readable medium of claim 17, wherein the payment tree enables the user to select at least one user payee from the payment tree and at least one user payer from the payment tree to allow a payment provider to process a payment from the selected user payer(s) to the selected user payee(s).

22. The transitory computer readable medium of claim 21, wherein the payment tree is updated to reflect the payment.

23. The transitory computer readable medium of claim 21, wherein the user selects the payee(s) by moving the selected payer(s) to a desired payee(s).

24. The transitory computer readable medium of claim 21, wherein the user selects the desired payer(s) by moving the selected payee(s) to a desired payer(s).
